(19) United States
(12) Patent Application Publication
(10) Pub. No.: US 2026/0236084 A1
(43) Pub. Date: Aug. 13, 2026

(54) SYSTEMS AND METHODS FOR DATA CENTER MANAGEMENT

(71) Applicant: Dell Products L.P., Round Rock, TX (US)

(72) Inventors: Nadia Henry, Georgetown, TX (US); Carlos Guillermo Henry, Georgetown, TX (US); Sudhir Vittal Shetty, Cedar Park, TX (US); Rhushabh Bhandari, Pflugerville, TX (US); Kwangnam Cho, Round Rock, TX (US); Deepak Gowda, Raleigh, NC (US)

(73) Assignee: Dell Products L.P., Round Rock, TX (US)

(21) Appl. No.: 19/047,715

(22) Filed: Feb. 7, 2025

(51) Int. Cl. G06F 1/324; G06F 1/20

(52) U.S. Cl. CPC G06F 1/324; G06F 1/206

(57) ABSTRACT

Systems and methods are provided for managing a data center. For instance, data center-level characteristics may be applied to an optimization application. The optimization application may calculate power limits for some or all of the information handling systems of the data center. An administrator may enforce the power limits, thereby causing the data center to operate at an energy usage level that may be expected to satisfy an objective, such as minimizing power use or maximizing performance.

### FIELD

The present disclosure generally relates to data centers that include multiple Information Handling Systems (IHSs), and, more particularly, managing such data centers.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A datacenter may include a large number of IHSs, such as servers, that are installed within chassis and stacked within slots provided by racks. A datacenter may include large numbers of such racks that are filled with servers, or other types of IHSs. In some cases, datacenter IHSs may be locally managed by an administrator, such as using keyboard, video display, and mouse (KVM) capabilities that are supported within the datacenter.

### SUMMARY

In various embodiments, an IHS (Information Handling System) includes: a plurality of managed hardware components; one or more processors; and one or more memory devices coupled to the one or more processors, the memory devices storing computer-readable instructions that, upon execution by the one or more processors, cause the IHS to: generate a forecasted energy use of the IHS over a first time period based on telemetry data corresponding to energy use of the IHS; receive data indicating a minimum value for a power limit of the IHS and data indicating an operating temperature range for a data center hosting the IHS; receive data indicating an energy cost for the data center, wherein the energy cost is based on the forecasted energy use of the IHS; determine the power limit of the IHS by applying an optimization function that uses the data indicating the minimum value for the power limit, the data indicating the operating temperature range, the data indicating the energy cost as constraints and applying an objective function to either minimize cost or maximize performance; and operate the IHS based on the power limit.

In various embodiments, a method includes: determining a forecasted energy use of an information handling system (IHS) over a first time period based on energy use data of the IHS; determining a minimum value for a power limit of the IHS and data indicating an operating temperature range for a data center hosting the IHS; determining a cooling cost for the data center based on the forecasted energy use and the data indicating an operating temperature range for a data center hosting the IHS; calculating the power limit of the IHS, subject to the minimum value for the power limit and the cooling cost as constraints and including applying an objective function to either minimize cost or maximize performance; and causing the IHS to operate according to the power limit.

In various embodiments, a computer-readable storage device having instructions stored thereon for managing a data center, wherein execution of the instructions by one or more processors of an information handling system (IHS) causes the one or more processors to: determine a forecasted energy use of the IHS over a first time period based on energy use data of the IHS; determine a cooling cost for the data center based on the forecasted energy use and data indicating an operating temperature range for a data center hosting the IHS; calculate a power limit of the IHS, subject to the cooling cost as a constraint and including applying an objective function to either minimize cost or maximize performance of the data center; and cause the IHS to operate according to the power limit.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a diagram illustrating certain components of a chassis configured, having IHSs installed within the chassis, according to some embodiments.

FIG. 2 is a diagram illustrating certain components of an IHS configured as a component of chassis, according to some embodiments.

FIG. 3 is an illustration of an example data center, according to some embodiments.

FIG. 4 is an illustration of an example optimizer application, adapted according to some embodiments.

FIG. 5 is an illustration of the operation of forecasting analytics component, according to some embodiments.

FIG. 6 is a flowchart describing certain steps of an example method, according to some embodiments.

### DETAILED DESCRIPTION

Various embodiments provide systems and methods for managing a data center, including optimizing a data center, subject to some constraints, to either maximize performance or minimize cost.

In a data center environment, there may be a variety of factors to be managed, such as power use, thermal output, acoustic output, and the like, sometimes referred to as telemetry. Other factors may include cost of data center infrastructure, including energy and cooling. Other factors may include data center usage, such as types of workloads that may be run on the information handling systems (IHSs) of the data center.

According to various embodiments, a management system for a data center may express data center constraints in a way that may be used by an optimizer algorithm. Constraints may include, e.g., acoustic output, such as keeping operation of IHSs within the data center below a decibel level, a temperature constraint, such as an operating temperature range for the data center, and a cost constraint, such as may be expressed as a dollar value for energy consumption inclusive of cooling.

Various embodiments may also define objective functions based on the data center operation. One objective function may be to minimize an electricity bill, and another objective function may be to maximize performance of the data center. An example of performance may include a quantity of input output operations per second (IOPS), where it is generally assumed that a higher quantity of IOPS may be associated with higher power use and that a lower quantity of IOPS may be associated with a lower power use. However, as noted above, constraints force an optimization to be within a particular range of power use. For instance, one constraint may include a minimum value for a power limit so as not to make performance of any particular IHS unacceptable.

In one example use case, a particular IHS may calculate a forecasted energy use for a time period (e.g., a day, week, month). The IHS (or a different IHS) may use the calculation to generate a cooling cost forecast for the data center as a whole. For instance, the forecasted energy use may be scaled over multiple IHSs of the data center, and that scaled forecasted energy use may form the basis for a cooling cost forecast. The cost of cooling and the cost of powering the IHSs in the data center may sum to a total cost forecast for the data center.

The IHS may run an optimizer application, where the optimizer application receives as inputs the forecasted power consumption, the operating temperature range for the data center (e.g., 15° C.-32° C.) and a minimum value for a power limit, where the minimum value is set so that it is expected not to cause undesirable performance.

The optimizer application may also receive further constraints, such as an acoustic constraint, a cooling cost function, and a maximum cost function.

The optimizer application may apply an objective function to either minimize the cost or maximize the performance of the data center. The output of the optimizer application may include power limits (sometimes referred to as power caps), which may be individual power limits for a set of IHSs, or even all IHSs, of the data center.

The technique may further include operating one or more of the IHSs according to the power limits. From the point of view of a particular IHS, enforcing a power limit may include, e.g., lowering or raising an operating parameter of the IHS. For instance, reducing clocking speed of a processor or a memory circuit of an IHS may be expected to reduce power use but may also be expected to reduce performance. Reducing or raising a clocking speed may also be accompanied by reducing or raising an operating voltage, respectively. However, the scope of embodiments may include any technique for enforcing a power limit.

Thus, various embodiments may advantageously determine and enforce power limits for IHSs in a data center, thereby causing the IHSs in a data center to operate according to the output of the optimization function. As a result, a data center administrator may cause the IHS as of the data center to behave in a way that provides acceptable performance and acceptable energy use (including cooling energy), subject to constraints.

By contrast, other systems may provide for determining power limits based on parameters at the IHS level, rather than the data center level. However, various embodiments that take into account data center-level characteristics (e.g., data center cooling costs and energy costs) may provide better performance and energy use at the data center level.

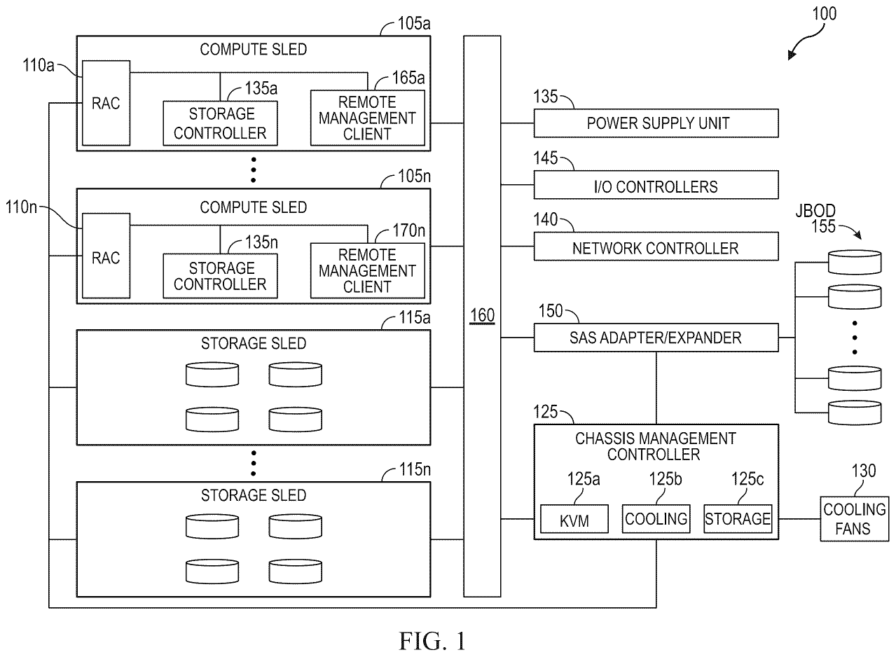

FIG. 1 is a block diagram illustrating certain components of a chassis 100 comprising one or more compute sleds 105a-n and one or more storage sleds 115a-n, where each of the sleds 105a-n, 115a-n may be configured to implement the systems and methods described herein to support management of a data center. Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

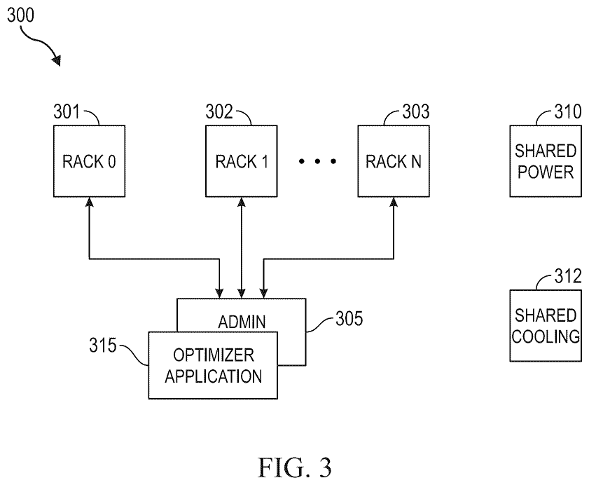

Multiple chassis 100 may be housed within a rack, such as any of the racks illustrated in FIG. 3. Data centers may utilize large numbers of racks, with various different types of chassis installed in the various configurations of racks. The modular architecture provided by the sleds, chassis and rack allow for certain resources, such as cooling, power and network bandwidth, to be shared by the compute sleds 105a-n and storage sleds 115a-n, thus providing efficiency improvements and supporting greater computational loads.

Chassis 100 may be installed within a rack structure that provides all or part of the cooling utilized by chassis 100. For airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air from within the sleds 105a-n, 115a-n installed within the chassis. A rack and a chassis 100 installed within the rack may utilize various configurations and combinations of cooling fans to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160. In various embodiments, backplane 160 may include various additional components, such as cables, wires, midplanes, backplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140 and power supply unit 135.

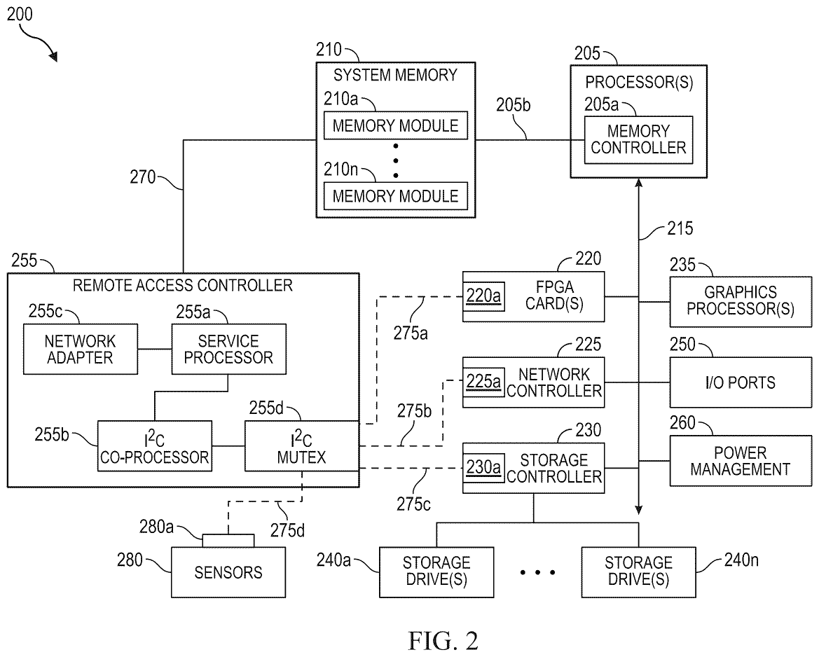

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n may be configured with hardware and software that provide leading-edge computational capabilities. Accordingly, services provided using such computing capabilities may be provided as high-availability systems that operate with minimum downtime. As described in additional detail with regard to FIG. 2, compute sleds 105a-n may be configured for general-purpose computing or may be optimized for specific computing tasks.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band and sideband (i.e., out-of-band) communications with various components of a compute sled 105a-n and chassis 100. Remote access controllers 110a-n may collect sensor data, such as temperature sensor readings, from components of the chassis 100 in support of airflow cooling of the chassis 100 and the sleds 105a-n, 115a-n. Remote access controllers 110a-n may collect data, such as for power use, memory use, compute power use, clocking, sled configuration, and the like, for their respective sleds.

As illustrated, chassis 100 also includes one or more storage sleds 115a-n that are coupled to the backplane 160 and installed within one or more bays of chassis 200 in a similar manner to compute sleds 105a-n. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. The storage sleds 115a-n may be utilized in various storage configurations by the compute sleds 105a-n that are coupled to chassis 100.

Each of the compute sleds 105a-n includes a storage controller 135a-n that may be utilized to access storage drives that are accessible via chassis 100. Some of the individual storage controllers 135a-n may provide support for RAID (Redundant Array of Independent Disks) configurations of logical and physical storage drives, such as storage drives provided by storage sleds 115a-n. In some embodiments, some or all of the individual storage controllers 135a-n may be HBAs (Host Bus Adapters) that provide more limited capabilities in accessing physical storage drives provided via storage sleds 115a-n and/or via SAS expander 150.

In addition to the data storage capabilities provided by storage sleds 115a-n, chassis 100 may provide access to other storage resources that may be installed components of chassis 100 and/or may be installed elsewhere within a rack housing the chassis 100, such as within a storage blade. In certain scenarios, such storage resources 155 may be accessed via a SAS expander 150 that is coupled to the backplane 160 of the chassis 100. The SAS expander 150 may support connections to a number of JBOD (Just a Bunch Of Disks) storage drives 155 that may be configured and managed individually and without implementing data redundancy across the various drives 155. The additional storage resources 155 may also be at various other locations within a datacenter in which chassis 100 is installed. Such additional storage resources 155 may also be remotely located.

As illustrated, the chassis 100 of FIG. 1 includes a network controller 140 that provides network access to the sleds 105a-n, 115a-n installed within the chassis. Network controller 140 may include various switches, adapters, controllers and couplings used to connect chassis 100 to a network, either directly or via additional networking components and connections provided via a rack in which chassis 100 is installed. Chassis 100 may similarly include a power supply unit (PSU) 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units.

Chassis 100 may also include various I/O controllers 145 that may support various I/O ports, such as USB ports that may be used to support keyboard and mouse inputs and/or video display capabilities. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power 135, network bandwidth 140 and airflow cooling 130 that are available via the chassis 100. The airflow cooling 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a compute sled, a storage sled, a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein for managing a data center. It should be appreciated that although the embodiments described herein may describe an IHS that is a compute sled or similar computing component that may be deployed within the bays of a chassis, other embodiments may be utilized with other types of IHSs. In the illustrative embodiment of FIG. 2, IHS 200 may be a computing component, such as compute sled 105a-n or other type of server, such as a 1RU server installed within a 2RU chassis, that is configured to share infrastructure resources provided by a chassis 100.

The IHS 200 of FIG. 2 may be a compute sled, such as compute sleds 105a-n of FIG. 1, that may be installed within a chassis, that may in turn be installed within a rack. Installed in this manner, IHS 200 may utilize shared power, network and cooling resources provided by the chassis and/or rack. IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b.

The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may include multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty components. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources or other peripheral components.

As illustrated, IHS 200 may include one or more FPGA (Field-Programmable Gate Array) card(s) 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of the logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as in computing different operations that are being offloaded from processor 205. The FPGA card 220 may also include a management controller 220a that may support interoperation with the remote access controller 255 via a sideband device management bus 275a.

Processor(s) 205 may also be coupled to a network controller 225 via in-band bus 215, such as provided by a Network Interface Controller (NIC) that allows the IHS 200 to communicate via an external network, such as the Internet or a LAN. In some embodiments, network controller 225 may be a replaceable expansion card or adapter that is coupled to a motherboard connector of IHS 200. In some embodiments, network controller 225 may be an integrated component of IHS 200.

A variety of additional components may be coupled to processor(s) 205 via in-band bus 215. For instance, processor(s) 205 may also be coupled to a power management unit 260 that may interface with the power system unit 135 of the chassis 100 in which an IHS, such as a compute sled, may be installed. In certain embodiments, a graphics processor 235 may be included within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255.

In certain embodiments, IHS 200 may operate using a BIOS (Basic Input/Output System) that may be stored in a non-volatile memory accessible by the processor(s) 205. The BIOS may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 255.

In certain embodiments, remote access controller 255 may operate from a different power plane from the processors 205 and other components of IHS 200, thus allowing the remote access controller 255 to operate, and management tasks to proceed, while the processing cores of IHS 200 are powered off. As described, various functions provided by the BIOS, including launching the operating system of the IHS 200, may be implemented by the remote access controller 255. In some embodiments, the remote access controller 255 may perform various functions to verify the integrity of the IHS 200 and its hardware components prior to initialization of the IHS 200 (i.e., in a bare-metal state).

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies. As a non-limiting example of a remote access controller, the integrated Dell Remote Access Controller (iDRAC) from Dell® is embedded within Dell PowerEdge™ servers and provides functionality that helps information technology (IT) administrators deploy, update, monitor, and maintain servers remotely.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as FPGA cards 220, network controller 225 and storage controller 230, are coupled to the IHS processor(s) 205 via an in-line bus 215, such as a PCIe root complex, that is separate from the I2C sideband bus connections 275a-d used for device management. In various embodiments, additional or different components of IHS 200 may be managed by remote access controller 225 through the use of sideband bus connections. The management functions of the remote access controller 255 may utilize information collected by various managed sensors 280 located within the IHS. For instance, temperature data collected by sensors 280 may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280.

In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280. In certain embodiments, the endpoint I2C controller 280a of the FPGA card 220 may correspond to the management controller 220a described above.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

FIG. 3 is an illustration of an example data center 300, according to some embodiments. Data center 300 includes N racks 301-303, where N is a positive integer greater than one, though this particular illustration shows three racks 301-303. However, the scope of implementations may include any appropriate quantity N of racks.

Each of the racks 301-303 may include one or more chassis, where an example chassis 100 is described above with respect to FIG. 1. Each chassis in a rack may include one or multiple IHSs, such as one or multiple compute sleds, storage sleds, or the like. In some examples, an IHS in a rack may be referred to as a server, though the scope of implementations is not limited to servers. An example IHS is discussed above with respect to FIG. 2.

Admin computing rack 305 may include one or multiple chassis having one or multiple IHSs that run applications for administration of the data center. Shared power resource 310 may include power converters, buses, and the like, to provide power to the racks 301-303, the admin rack 305, shared cooling resource 312, and any other components of the data center 300. For instance, shared power resource 310 may receive electricity from a power line (not shown) or substation (not shown), which is external to the data center 300, and distribute that power to the various deployed systems within the data center 300. Shared cooling resource 312 may include various data center-level cooling technologies, which support heat removal from racks 301-303, admin rack 305, shared power resource 310, and any other appropriate components of data center 300. In one example, shared cooling resource 312 may include a central air conditioning system, which operates to keep the data center 300 within a specified temperature range (e.g., 15° C.-32° C.). Shared cooling resource 312 may include other technologies, such as central fluid cooling, where fluid from one or more of the racks 301-303 may circulate through shared cooling resource 312 for heat to be removed and the fluid to be recirculated.

As noted above, shared power resource 310 may power the various components of the data center 300, including the shared cooling resource 312. Thus, power usage within the data center 300 may include not only components directly related to powering computing and storage resources (e.g., racks 301-303 and admin rack 305) but may also include power usage related to shared cooling resource 312. Thus, as power use increases for racks 301-303, that may be expected to increase heat released into the atmosphere of the data center 300, which may place increased burden on the shared cooling resource 312, and the shared cooling resource 312 may in response also consume more power.

Shared power resource 300 and shared cooling resource 312 represent data center-level resources. In other words, shared power resource 300 and shared cooling resource 312 are not specific to any particular rack, but rather, serve all N of the racks 301-303.

Admin rack 305 may include an IHS (not shown), which communicates with individual ones of the IHSs of the racks 301-303. For instance, in one example, the various IHSs within rack 301 may communicate with an IHS of admin rack 305 over a network, such as ethernet or a wireless network such as Wi-Fi. In one example, each of the IHSs may include a remote access controller, which in some implementations may also be referred to as a baseboard management controller (BMC). Example remote access controllers 110 and 255 are discussed above with respect to FIGS. 1 and 2. The remote access controller for a given IHS may monitor configuration of the IHS, monitor performance characteristics of the IHS, report data from monitoring, and control some operations of various components of the IHS. Furthermore, a given IHS may transmit remote access controller data to an IHS of the admin rack 305, and the IHS of the admin rack 305 may communicate to an IHS of a given rack to cause action on the part of the remote access controller.

Optimizer application 315 may include computer-readable instructions, which when executed by one or more processors of an IHS of the admin rack 305, causes the one or more processors to perform optimization for management of the data center 300. In one example, the optimizer application 315 may communicate with remote access controllers of IHSs within the racks 301-303 to gather remote access controller data, perform optimizer calculations using that remote access controller data, and transmit control data including individual power limits to each of the respective remote access controllers at each of the racks 301-303.

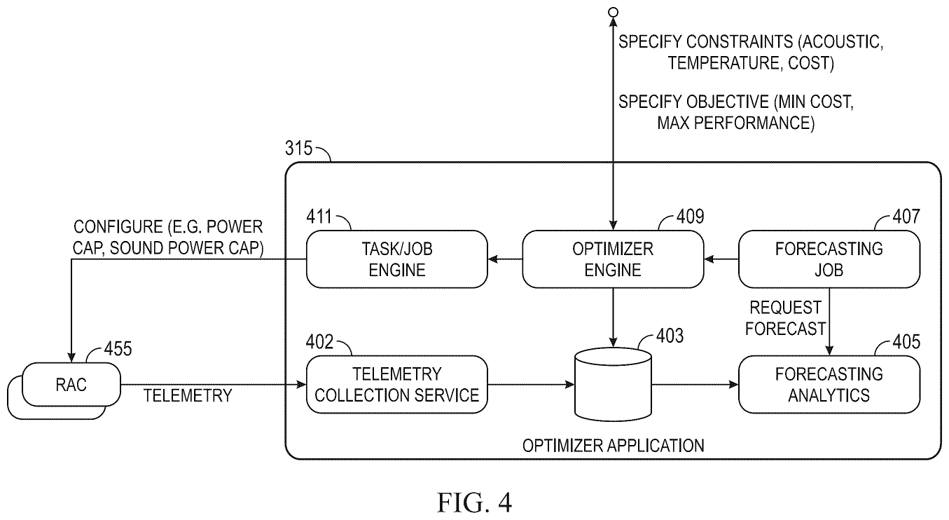

FIG. 4 is an illustration of an example optimizer application 315, adapted according to some embodiments. Optimizer application 315 is in communication with a remote access controller 455, which may be configured the same as or similar to remote access controller 110 of FIGS. 1 and 255 of FIG. 2. The actions described as being performed by optimizer application 315 with respect to remote access controller 455 may be performed for some or all of the remote access controllers in each of the racks 301-303.

Telemetry collection service 402 is a module of optimizer application 315, and telemetry collection service 402 may communicate with remote access controller 455 to harvest telemetry data from remote access controller 455. Examples of telemetry data that may be harvested include instantaneous power data, energy use data over a period of time, thermal data, workload data, configuration data for a respective IHS, operational status data, and the like. In fact, any appropriate telemetry data may be harvested from remote access controller 455 by telemetry collection service 402.

Telemetry collection service 402 may store the telemetry data in database 403. Telemetry collection service 402 may collect the telemetry data periodically, such as once per minute or other appropriate time, to build a collection of historical performance data by an IHS associated with remote access controller 455. In one example, the IHS that is associated with remote access controller 455 may have oscillating power use. Oscillating power use may include peak power use during some times, a trough in power use at other times, and the oscillating power use may show a pattern over time. For instance, the telemetry data over time and stored in database 403 may indicate daily cycles of power use for the IHS, with a peak time of day and a trough time of day. And while power use for each day may be different, a pattern may emerge showing that each day is similar. In other words, power use in some systems may not be constant, but may vary from time to time.

Forecasting job component 407 may request a forecast for energy use from forecasting analytics component 405. In response, forecasting analytics component 405 may request historical energy use data from the database 403. Forecasting analytics component 405 may then use the historical energy use data to perform calculations to generate forecast energy use data, which may represent a prediction of energy use over a specified timeframe (e.g., a day, week, a month). In one particular example, the forecasting analytics component 405 may include a trained machine learning (ML) model, which may receive telemetry data as an input and may output forecast energy use data. The forecast energy use data may be specified in terms of power (e.g., watts) over the specified time (e.g., day) or may be specified as energy (e.g., kilowatt hours). The forecast energy use data may be specified in any appropriate manner using any appropriate unit.

The forecasting job component 407 may then transmit the forecast energy use data to the optimizer engine 409. The optimizer engine 409 may then apply an optimizer function using specified constraints and a specified objective to generate power limit data. Operation of optimizer engine 409 is described in more detail below. The output of optimizer engine 411 may include data indicating a power limit, such as a not-to-exceed level of power (e.g., watts) over the specified timeframe (e.g., day, week, month). The task engine 411 may receive the output of the optimizer engine 409 and may configure the remote access controller 455 according to the power limit.

Once configured according to the power limit, the remote access controller 455 may cause its respective IHS to operate within the power limit. For instance, the respective IHS may increase or decrease a clocking speed, and operating voltage, or other appropriate parameter to cause the IHS to consume power within the power limit. For instance, in the example of FIG. 2, remote access controller 255 may be configured according to a power limit, and it may cause a clocking speed of the system memory 210, the processor 205, the graphics processor 235, and the FPGA cards 220 to either be increased or decreased in order to meet the power limit during operation. As a result, the system memory 210, the processor 205, the graphics processor 235, and the FPGA cards 220 may be expected to consume power over time but not exceed the power limit that was configured into the remote access controller 255 by the optimizer application 315.

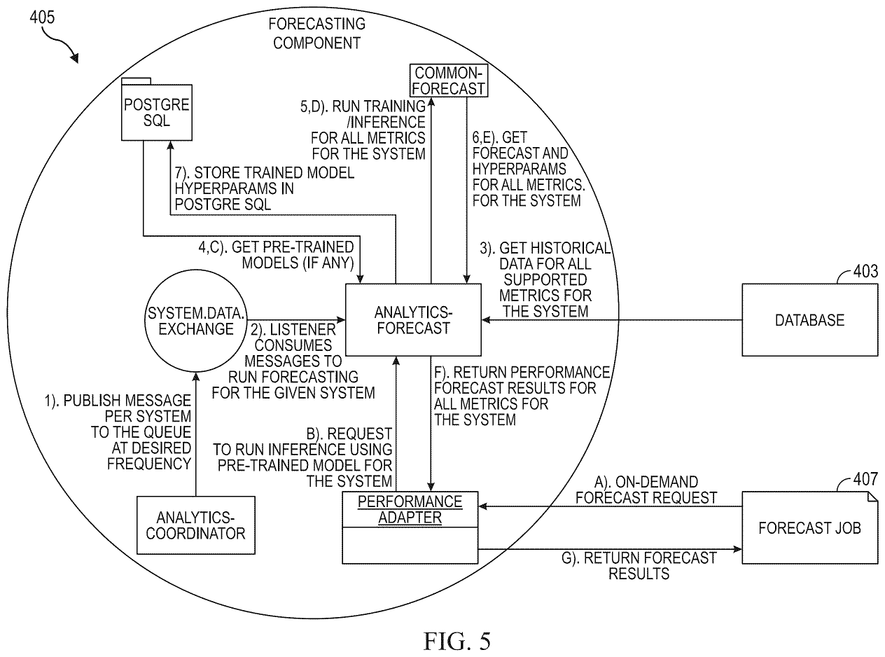

FIG. 5 is an illustration of the operation of forecasting analytics component 405, according to some embodiments. Analytics component 405 includes two different method flows. A first method flow has actions 1-7, which correspond to training of an ML model to generate forecast energy use data. A second method flow has actions a-g, which correspond to using the trained ML model for prediction.

At action 1, the forecasting analytics component 405 triggers itself to begin a training operation by publishing a message, which triggers the training. As the message comes in, it is consumed at action 2. At action 3, the forecasting analytics component 405 acquires historical data (telemetry data) from database 403. At action 4, the forecasting analytics component 405 determines whether there are any pre-trained models, which it may use instead of training a new model. Assuming that there are no appropriate pre-trained models, then at action 5, the forecasting analytics component 405 runs training for various metrics for the system. In this example, action 5 is the training itself, and various embodiments may use any appropriate ML algorithms to perform the training. An example of an appropriate training algorithm may include error reduction. The input for the training may include historical data from the database 403. In some examples, the forecasting analytics component 405 may train at least one ML model for each IHS each time a prediction is requested for that IHS. However, in some instances, an existing trained ML model may be used or reused for prediction.

At action 6, the trained ML model has been generated, and it may include any appropriate data, including a multitude of metrics and a multitude of weights, though the type of data for a generated ML model may depend on the particular ML model. At action 7, the forecasting analytics component 405 stores the trained model to a database, which may be a separate database from the database 403 (or may be the same as the database 403 in some embodiments).

At action a, a request is received for a forecast. At action b, there is a request to run prediction using the pre-trained model. At action c, forecasting analytics component 405 retrieves the pre-trained ML model from the database. At action d, the forecasting analytics component 405 uses the trained ML model to generate a forecast. For instance, the analytics component 405 may apply relatively recent energy use data from the database 403 for a particular remote access controller as input to the trained ML model during a prediction operation. The trained ML model may then output power use forecast data for that particular remote access controller.

At actions f and g, the forecasting analytics component 405 returns the power use forecast data to the forecasting job component 407. As noted above, with respect to FIG. 4, the power use forecast data may then be provided to the optimizer engine 409 to generate a power limit for the IHS associated with the remote access controller.

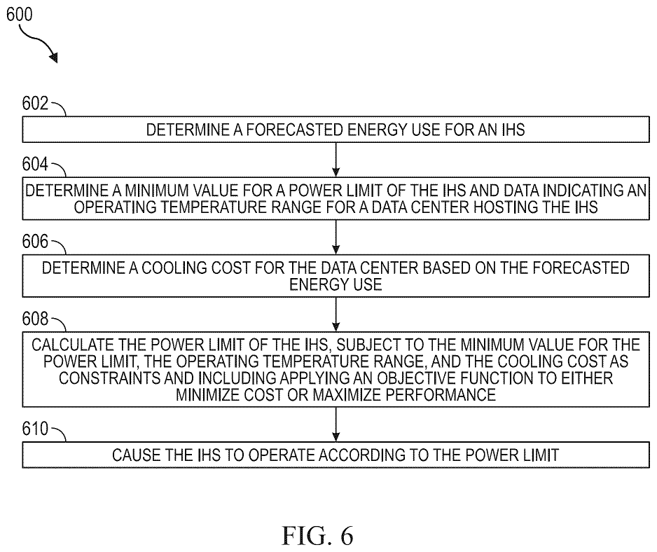

FIG. 6 is an illustration of an example method 600, which may be performed by an IHS to determine a power limit for either that IHS or another IHS, according to some embodiments. For instance, an IHS may include one or more processors, which execute computer-readable instructions to perform the actions of optimizer application 315.

At action 602, the optimizer application determines a forecasted energy use for an IHS. In one example, an IHS, such as in admin rack 305 of FIG. 3 may determine a forecasted energy use for an IHS, such as may be disposed within any of the racks 301-303. In one example, the forecasted energy use is in kilowatt hours or other appropriate unit, and an example of determining a forecast energy use is described above with respect to forecasting analytics component 405 of FIGS. 3-4. That energy use may also be referred to as a forecasted energy consumption (FEC).

Action 604 includes determining a minimum value for a power limit of the IHS. In one example, a minimum value for the power limit (MinPC) may be set so as not to cause undesirable performance. The minimum value for the power limit may be known beforehand based on experimentation, simulation, or observation.

In these examples, the power limit is a not-to-exceed value for power use and may also be referred to as a power cap.

Action 604 may also include determining data indicating an operating temperature range for a data center hosting the IHS. For instance, an operating temperature range for a data center may be 15° C.-32° C., though the scope of implementations is not limited to any particular operating temperature range.

Action 606 may include determining a cooling cost for the data center based on the forecasted energy use. Action 606 may include converting the FEC in kWh to BTU (British Thermal Units).

$$ForecastedEnergy ( BTU ) = FEC ( kWh ) ⋆ 3412.142 \qquad Eq . ( 1 )$$

EER (Energy Efficiency Ratio) is a measure of the efficiency of air conditioning systems, including Computer Room Air Conditioners (CRAC).

$$Cooling Power Forecast = ForecastedEnergy ( BTU / hr ) / EER \qquad Eq . ( 2 )$$

Action 606 may further include converting the cooling power forecast into another unit, such as watts. Cooling Energy Forecast EER (Energy Efficiency Ratio) is a measure of the efficiency of air conditioning systems, including Computer Room Air Conditioners (CRAC).

$$Cooling Power Forecast ( W ) = ForecastedEnergy ( BTU / hr ) / EER \qquad Eq . ( 3 )$$

$$Cooling Energy Forecast ( kWh ) = Cooling Power Forecast ( W ) ⋆ duration ( h ) \qquad Eq . ( 4 )$$

A Cooling Cost Forecast may be calculated using Equation 5.

$$CoolingCostForecast = {\sum }_{j = StartTime}^{EndTme} Cooling Energy Forecast ( j ) ⋆ costPerWh ( j ) \qquad Eq . ( 5 )$$

Action 608 includes calculating the power limit of the IHS, subject to the minimum value for the power limit (MinPC), the operating temperature range, and the cooling cost as constraints. In some examples, each constraint represents a condition that the eventual solution will satisfy. For instance, if the solution includes a power limit (cap) value for an IHS, then the constraints are conditions that the power limit value for the IHS is tailored to satisfy. Action 608 may also include applying an objective function to either minimize cost or to maximize performance of the data center.

Action 608 may include using further constraints. An example constraint may include acoustics (operation of an IHS <=decibel level). This indirectly translates into an acoustic power cap value. The power cap may be used as a not-to-exceed value for the power consumption which indirectly affects the fan speed required to cool down the system. PC (i) is the power cap value of an infrastructure component in the data center. According to Equation 6, the optimization application 315 may set the power cap (PC) for an individual one of the IHSs (i) below a value for an acoustic power cap if appropriate. The acoustic power cap may be known from simulation, experimentation, or operation.

$$PC ( i ) <= Acoustic Power Cap ( APC ) . \qquad Eq . ( 6 )$$

Calculating a power limit may include accounting for operation internal to an IHS (or internal to a rack) with cost imposed on the data center as a whole. As noted above, an IHS may include internal cooling resources, such as fans in a rack. If internal cooling of an IHS saves X KW of power due to an increase by 1° C. in the operating temperature of the IHS, then the total savings is X*TΔ. However, allowing an IHS to increase its operating temperature by 1° C. may put further burden on the shared cooling resource 312. If the power required for the shared cooling resource 312 rises by Y kW of power due to an increase by 1° C. of the IHS, then the total cost rises by Y*TΔ. Net savings is (X-Y)*TΔ.

Furthermore, action 608 may include applying a maximum cost constraint for total energy cost for the data center. For instance, total energy cost may include operating energy cost for some or all of the IHSs plus the cost of operating shared cooling resources 312. Max Cost (<=$ cost) (MaxCost in $ or local currency) expressed as a daily energy cost for the data center also be used as a constraint. This may be a sum of the cost across all devices (infrastructure+cooling) in the data center. The cost per kWh (may vary by time of day and geo-location of data center) aggregated across the infrastructure components. The cooling cost may be calculated using Equation 5 and be based on the EER of the cooling equipment and the cooling power required to cool the infrastructure components.

$$InfrastructureCost ( i ) = {\sum }_{j = StartTime}^{EndTime} ForecastedEnergyComsumption ( j ) * costPerkWh ( j ) \qquad Eq . ( 7 )$$

$${\sum }_{i = 1}^{NumDevices} InfrastuctureCost ( i ) + CoolingCostForecast < Max Cost . \qquad Eq . ( 8 )$$

Equation 8 scales the energy cost over multiple IHSs in the data center (e.g., all IHSs). In other words, the determinations made at actions 602-606 may be performed for each individual IHS in the data center. Equation 8 may include summing infrastructure cost, calculated for each of the IHSs, and cooling cost, calculated for each of the IHSs. The result is a total energy cost for the data center, taking into account costs attributable to individual IHSs.

Action 608 may further include applying an objective function, where the objective function may either minimize the cost of energy, as expressed in Equation 8, or may maximize performance, such as by minimizing a power under-allocation. In these examples, the objective function is a mathematical expression that defines the goal of the problem, which is either to be maximized or minimized. Furthermore, the objective function may quantify the performance or cost associated with a given set of decision variables to guide the search for an optimal solution within the feasible region defined by the constraints.

In one example, an objective function may be expressed as minimizing cost or maximizing performance within the constraint boundary:

$$Minimize cost : Min ( {\sum }_{i = 1}^{N u m D e v i c e s} InfrastructureCost ( i ) + Cooling Cost Forecast ) \qquad Eq . ( 9 )$$

Or Maximize performance: Minimize the power under-allocation Min(PUA(i))

$$PowerUnderAllocated ( PUA ( i ) ) = {\sum }_{j = 1}^{NumForecast} ForecastValue ( j ) - PC ( i ) where ForecastValue > PowerCap \qquad Eq . ( 10 )$$

In the example above, Equation 9 provides an objective function to minimize the cost expressed in Equation 8. Alternatively, a user might instead choose to maximize performance of the data center by using the objective function expressed in Equation 10. In some implementations, the optimizer application 315 may provide for administrator input to choose an objective function.

The above input, constraints, and objective function may be treated as an optimization problem that may be programmatically modeled and solved using any appropriate technique. In this example, the optimization problem may aim to find power limit (cap) values for the individual IHSs to yield the best possible value of the objective function while satisfying the constraints. One particular technique that may be used in some implementations may include modeling and solving using a language such as MiniZinc.

The output of the optimization application 315 may include PowerCap Values (PC), such as a set of power cap values (e.g., Watts) for each of the servers in the data center.

Each PC value may be generated for each individual IHS in the data center. For instance, a given PC value may be transmitted to its corresponding RAC, such as illustrated in FIG. 4. The RAC may cause configuration changes for its associated IHS, such as by setting a clock speed and/or operating voltage to control power use by that IHS consistent with its assigned PC value. In some examples, the PC values may be not-to-exceed power values.

The scope of implementations is not limited to the series of actions shown in FIG. 6. Rather, various implementations may add, omit, rearrange, or modify one or more of the actions. In one example, an administrator, such as may use optimization application 315, may set optimization application 315 to run every week, every month, or at another appropriate time.

Thus, various embodiments provide the ability to specify constraints along with different dimensions, such as acoustics, cost, and data center temperature. Various embodiments may also provide the ability to do data center-level optimizations for a targeted objective function to optimize an IHS's performance within the data center constraints. Furthermore, various embodiments may leverage forecasting analytics to predict power consumption and to predict operating costs that may be used as inputs to the constraint solver.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An IHS (Information Handling System) comprising:
a plurality of managed hardware components;
one or more processors; and
one or more memory devices coupled to the one or more processors, the memory devices storing computer-readable instructions that, upon execution by the one or more processors, cause the IHS to:
generate a forecasted energy use of the IHS over a first time period based on telemetry data corresponding to energy use of the IHS;
receive data indicating a minimum value for a power limit of the IHS and data indicating an operating temperature range for a data center hosting the IHS;
receive data indicating an energy cost for the data center, wherein the energy cost is based on the forecasted energy use of the IHS;
determine the power limit of the IHS by applying an optimization function that uses the data indicating the minimum value for the power limit, the data indicating the operating temperature range, the data indicating the energy cost as constraints and applying an objective function to either minimize cost or maximize performance; and
operate the IHS based on the power limit.

2. The IHS of claim 1, wherein the computer-readable instructions to cause the IHS to generate the forecasted energy includes computer-readable instructions to cause the IHS to:
receive telemetry data from a baseboard management controller (BMC) of the IHS, wherein the telemetry data includes energy use data over a second time period, which is previous to the first time period;
apply the telemetry data as an input to a trained machine learning (ML) model; and
receive the forecasted energy data as an output from the trained ML model.

3. The IHS of claim 1, wherein the IHS is configured to increase or decrease a clocking speed of the one or more processors based on the power limit.

4. The IHS of claim 1, wherein the IHS is further configured to receive input indicating an acoustic limit, wherein the computer-readable instructions to cause the IHS to apply the optimization function includes computer-readable instructions to cause the IHS to apply the acoustic limit as a constraint.

5. The IHS of claim 4, wherein the acoustic limit causes the optimization function to reduce the power limit.

6. The IHS of claim 1, wherein the data indicating the energy cost includes a cooling cost for the data center.

7. The IHS of claim 6, wherein the computer-readable instructions to cause the IHS to receive the data indicating the energy cost includes computer-readable instructions to cause the IHS to:
forecast the cooling cost for the data center based on the forecasted energy use of the IHS and the operating temperature range for the data center.

8. The IHS of claim 6, wherein the computer-readable instructions to cause the IHS to receive the data indicating the energy cost includes computer-readable instructions to cause the IHS to:
forecast the cooling cost for the data center based on the forecasted energy use of the IHS, scaled to a total quantity of IHSs in the data center, and efficiency of a cooling system of the data center, and the operating temperature range for the data center.

9. The IHS of claim 6, wherein the computer-readable instructions to cause the IHS to receive the data indicating the energy cost includes computer-readable instructions to cause the IHS to:
sum an energy cost for the IHS with a quantity of other IHSs in the data center.

10. The IHS of claim 6, wherein the computer-readable instructions to cause the IHS to apply the optimization function includes computer-readable instructions to cause the IHS to:
forecast the cooling cost for the data center based on the forecasted energy use of the IHS and the operating temperature range for the data center;
sum an energy cost for the IHS with a quantity of other IHSs in the data center; and
minimize the energy cost and the cooling cost, subject to the constraints.

11. The IHS of claim 1, wherein the computer-readable instructions to cause the IHS to apply the optimization function includes computer-readable instructions to cause the IHS to:
minimize a power under-allocation, wherein the power under-allocation is based on the forecasted energy use.

12. A method comprising:
determining a forecasted energy use of an information handling system (IHS) over a first time period based on energy use data of the IHS;
determining a minimum value for a power limit of the IHS and data indicating an operating temperature range for a data center hosting the IHS;
determining a cooling cost for the data center based on the forecasted energy use and the data indicating an operating temperature range for a data center hosting the IHS;
calculating the power limit of the IHS, subject to the minimum value for the power limit and the cooling cost as constraints and including applying an objective function to either minimize cost or maximize performance; and
causing the IHS to operate according to the power limit.

13. The method of claim 12, wherein the method is performed by the IHS.

14. The method of claim 12, wherein the method is performed by another IHS different from the IHS.

15. The method of claim 12, wherein applying the optimization function includes:
summing an energy cost for the IHS with a quantity of other IHSs in the data center; and
minimizing the energy cost and the cooling cost, subject to the constraints.

16. The method of claim 12, wherein applying the optimization function includes:
minimizing a power under-allocation, wherein the power under-allocation is based on the forecasted energy use.

17. A computer-readable storage device having instructions stored thereon for managing a data center, wherein execution of the instructions by one or more processors of an information handling system (IHS) causes the one or more processors to:
determine a forecasted energy use of the IHS over a first time period based on energy use data of the IHS;
determine a cooling cost for the data center based on the forecasted energy use and data indicating an operating temperature range for a data center hosting the IHS;
calculate a power limit of the IHS, subject to the cooling cost as a constraint and including applying an objective function to either minimize cost or maximize performance of the data center; and
cause the IHS to operate according to the power limit.

18. The computer-readable storage device of claim 17, wherein the instructions to cause the IHS to apply the optimization function includes instructions to cause the IHS to:
sum an energy cost for the IHS with a quantity of other IHSs in the data center; and
minimize the energy cost and the cooling cost, subject to the constraints.

19. The computer-readable storage device of claim 17, wherein the instructions to cause the IHS to apply the optimization function includes instructions to cause the IHS to:
minimize a power under-allocation, wherein the power under-allocation is based on the forecasted energy use.

20. The computer-readable storage device of claim 17, wherein the instructions to cause the IHS to determine the cooling cost includes instructions to cause the IHS to:
forecast the cooling cost based on the forecasted energy use of the IHS and an operating temperature range for the data center.
